(19) United States
(12) Patent Application Publication
(10) Pub. No.: US 2005/0281259 A1
(43) Pub. Date: Dec. 22, 2005

(54) Method of generating a monitoring datagram

(76) Inventor: Kevin Mitchell, Edinburgh (GB)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/129,188

(22) Filed: May 13, 2005

(30) Foreign Application Priority Data
Jun. 19, 2004 (GB) 0413751.9

(51) Int. Cl. H04L 12/56

(52) U.S. Cl. 370/389

(57) ABSTRACT

A method of generating a monitoring datagram for a predetermined network includes generating an initial datagram and encapsulating the initial datagram with a shim header, where the shim header has a first shim entry and a second shim entry, the first and second shim entries are associated with the predetermined network, the first shim entry is next to and follows the second shim entry, and where the first shim entry identifies the initial datagram as having a monitoring status.

The present invention relates to a method of generating a monitoring datagram of the type used, for example, to harvest data from routers in a network, for example, a Multi-Protocol Label Switching network. The present invention also relates to a method of and apparatus for processing the monitoring datagram.

### BACKGROUND ART

In the field of packet-switched communications, there is an increasing trend to communicate latency intolerant data over networks. The increasing use of real-time applications, such as high-quality video and audio, and Voice-over-IP traffic has resulted in a need to speed-up network traffic flow to meet the Quality of Service (QoS) standards required by such applications.

Multi-protocol Label Switching (MPLS) is a standardised technology devised with the aim of increasing speed of traffic flow in networks, whilst making the networks easier to manage. MPLS networks are deployed within other networks.

In MPLS, a packet, for example an Internet Protocol (IP) packet, is received at a so-called “ingress point”, usually a first router located at an edge of the MPLS network, where the first router “wraps” the IP packet in an MPLS packet using an MPLS shim header. The MPLS shim header has an MPLS shim entry that includes a label to identify a predetermined path, known as a “Label Switched Path” (LSP), for the IP packet to follow through the MPLS network, i.e. using specified routers within the MPLS network, to an “egress point”, which is usually a second router located at another edge of the MPLS network. By using a predetermined sequence of router, routers do not have to spend time looking-up addresses of subsequent routers for onward transmission of packets. Also, the ability to use explicit routes permits the sending of traffic along routes that are not necessarily shortest, but allow so-called “traffic engineering” within the network, thereby making it possible to direct traffic away from congested areas of the network or through low-cost routing parts of the network.

MPLS networks can also be nested. In such situations, when an MPLS packet reaches an edge of another MPLS network through which the packet has to “tunnel”, the MPLS packet is prefixed with another MPLS shim header, thereby encapsulating the first MPSL packet within a second, new, MPLS packet corresponding to the MPLS network through which the MPLS packet needs to tunnel. A stack of shim headers is therefore constructed.

Clearly, in such networks, as in others, it is desirable to monitor, through measurement, aspects of network performance, for example, packet loss, packet delay and/or packet jitter on a flow between two points in a network.

In the case of a “micro-flow”, where all packets are of a same type, the protocol in use may provide assistance in measuring packet loss. For example, a Transmission Control Protocol (TCP) flow will contain sequence numbers that can assist in detecting packet loss. But even so, care must be taken not to confuse reordered packets with lost packets, particularly when the measurement points are not collocated with the originator and destination of the flow. For flows that are more aggregated than microflows, or where a protocol being used is unable to assist in measuring packet loss, packet loss measurement is often more complex. Sometimes, routers can be configured to capture packet and byte counts at the flow level, but whilst such information can be used to estimate traffic rates, it is less useful for determining loss rates in mid-flow due to the difficulty of sampling counters at monitoring points as a packet passes.

It is also not possible to base a solution on a Simple Network Management Protocol (SNMP), because information obtained from Management Information Bases (MIBs) is often slightly stale in some router architectures. Therefore, a solution based upon SNMP is unattractive. In the absence of signalling, the point within a flow of packets at which a router starts to monitor the flow may also vary, further complicating the analysis of the readings. Consequently, measurements based on this technique tend to give only course-grained loss rates that reveal little as to how the rate varies over shorter time intervals.

Other known approaches rely on using hardware probes and hashing techniques. In its simplest form, a probe computes a hash value for every packet that passes the probe. Probes at both an ingress point and an egress point use a same hashing function, and agree on a particular hash value, N. Every time a packet hashes to the hash value, N, the probe records the current packet count total for flow associated with the packet. If the hash function is discriminating enough, this technique can allow the packet counts to be correlated between the two probes to compute accurate loss rates. The packets that pass the test, mark points in the stream and the probes can then synchronize their measurements at these points. The sophistication required in such techniques arises from a need to control the rate at which packets can pass the test when the monitoring points have no control over the makeup of the packets in the flow. If the matched packets are too close together then the readings can become ambiguous, particularly when packets are frequently lost. If a packet rarely passes the test then our ability to measure loss rates on a fine timescale is reduced.

In some cases, we can simplify the above implementation by injecting test packets into a flow of packets that can be easily and uniquely recognised by the probes, thereby avoiding relying on adaptive hashing techniques, because the rate at which the test packets are generated is now controllable. Of course, it is necessary to ensure that the test packets do not disrupt the recipient(s) of the flow of packets. For a single micro-flow, this may be impossible, but for an aggregated flow, with many recipients for individual micro-flows, adding an addition micro-flow of test packets should cause no disruption. However, without reconfiguring the routers, it may be difficult to guarantee that injected test packets will be treated identically to all the other packets in a flow of packets; for example, the test packets may follow a different route to the destination of the flow of packets, or be subjected to different queuing treatment. Also, the likelihood of packet reordering is increased, complicating the loss analysis.

Other known approaches simplify the above-described solution even further, trying to estimate an overall loss rate by the loss rate experienced by the artificially injected packets. However, this solution requires high volumes of active traffic to be injected to achieve statistically reliable results, and the potentially different QoS treatment of such packets makes it hard to draw any firm conclusions from such results.

A hybrid approach is also possible when a monitoring point is co-located with the source of a micro-flow. In such a situation, special IPv4 options or IPv6 header extensions can be used to tag a user packet for monitoring purposes without disrupting the end-point of the flow, as long as the Maximum Transmission Unit (MTU) is not exceeded. A modified hashing function then recognises the presence of such headers, or a destination host can be configured to extract and process such headers. Also, the headers can be generated at a rate under the control of a management process, and a kernel module can be used to introduce necessary options/extensions in the source network element responsible for generating the test packets.

However, this hybrid technique is, in fact, more problematic than other solutions when a monitoring point is downstream of a point where packets are generated. Also, a passive probe clearly cannot modify packets as they pass the probe, and adding extension headers to user packets as the packets pass through a router may have some undesirable ramifications.

### DISCLOSURE OF INVENTION

According to a first aspect of the present invention, there is provided a method of generating a monitoring datagram for a predetermined network, the method comprising the steps of: generating an initial datagram; encapsulating the initial datagram with a shim header having a first shim entry and a second shim header, the first and second shim entries being associated with a predetermined network; wherein the first shim entry is next to and follows the second shim entry, the first shim entry identifying the initial datagram as having a monitoring status.

It should be appreciated that references herein to the “initial datagram” are not intended to refer to unencapsulated datagrams only, and the use of encapsulated datagrams as the initial datagram is also contemplated.

The method may further comprise the step of: further encapsulating the datagram encapsulated by the second shim entry using a third shim entry associated with another network distinct from the predetermined network.

The first shim entry may comprise a label. The first label may be a NULL label.

The initial datagram may be an Internet Protocol datagram.

The predetermined network may support Label Switched Paths. The predetermined network may support an MPLS protocol.

The monitoring datagram may comprise temporary data to ensure a payload of the initial datagram is of an initial predetermined length.

Upon receipt of an encapsulated datagram it may be processed by: identifying a first shim entry and a second shim entry associated with the predetermined network, the first shim entry being next to and following the second shim entry; and recording data of a predetermined type relating to the datagram in response to the first shim entry bearing an identifier to identify the datagram as having a monitoring status.

The data of the predetermined type may be associated with the monitoring datagram and a predetermined path being followed by the monitoring datagram. The data of the predetermined type may be at least one of: timestamp data, a label, an exp field, a packet count and an interface address. The timestamp data may be a time of the recordal of the data of the predetermined type.

The data of the predetermined type may be recorded by appending the data of the predetermined type to a payload associated with the second shim entry.

The data of the predetermined type may be recorded by modifying at least part of the payload of the datagram so as to contain the data of the predetermined type.

According to a second aspect of the present invention, there is provided a method of calculating a network performance statistic comprising the steps of: generating a monitoring datagram as set forth in accordance with the first aspect of the present invention; harvesting monitoring data by processing, at least once, the monitoring datagram, by identifying a first shim entry (300) and a second shim entry (306) associated with the predetermined network (100), the first shim entry (300) being next to and following the second shim entry, and (306) recording data of a predetermined type relating to the datagram in response to the first shim entry (300) bearing an identifier to identify the datagram as having a monitoring status; and determining the network performance statistic using the harvested monitoring data.

The network performance statistic may be datagram loss.

The network performance statistic may be an end-to-end delay of the monitoring datagram between an ingress point and an egress point associated with a path for routing the monitoring datagram.

The network performance statistic may be an internal delay of a network element.

The method may include retrieval of monitoring data from an encapsulated monitoring datagram by: receiving, at an egress point of a communications network, the monitoring datagram, the monitoring datagram comprising a payload, the first shim entry and the second shim entry, the first and second shim entries corresponding to a label stack; discarding the second shim entry to reveal the first shim entry as an uppermost shim entry in the label stack; discarding the first shim entry to reveal a header; and forwarding the payload of the monitoring datagram to an appropriate network element in accordance with the header.

The payload of the monitoring datagram may be incorporated into a payload associated with the header.

A computer program element may comprise computer program code means to make a computer execute a method as set forth above.

The computer program element may be embodied on a computer readable medium.

According to a third aspect of the present invention, there is provided an apparatus for processing a monitoring datagram, the apparatus comprising: an ingress port for receiving a datagram comprising a plurality of headers corresponding to a protocol stack; a data processing unit for supporting a header analysis entity, the analysis entity being arranged to identify, when in use, a first shim entry and a second shim entry associated with a predetermined network, the first shim entry being next to and following the first shim entry, and the header analysis unit being further arranged to record data of a predetermined type relating to the datagram in response to the first shim entry bearing an identifier to identify the datagram as a monitoring datagram.

A communications network may comprise the apparatus as set forth in relation to the third aspect of the invention.

An interface apparatus may comprise the apparatus as set forth above in relation to the third aspect of the present invention.

The interface apparatus may be arranged to retain at least one count of packets that pass, when in use, through the interface apparatus. The at least one count may be of packets having a predetermined parameter associated with handling of the packets by the interface apparatus. The predetermined parameter may be at least one respective path, for example, a label switched path. The at least one count may also relate to other attributes, for example, EXP bits, to distinguish flows of packets over the at least one respective path. For the avoidance of doubt, it should be appreciated that the above counts may be used in conjunction with the other aspects of the invention set forth herein.

The interface apparatus may be arranged to generate monitoring datagrams for a path to be monitored in response to an absence of receipt of monitoring datagrams for the path for a predetermined period of time. The interface apparatus may cease generation of monitoring datagrams for the path in response to receipt of a monitoring datagram for the path.

The interface apparatus may be a GBIC.

According to a fourth aspect of the present invention, there is provided a monitoring datagram comprising: a payload; a plurality of headers corresponding to a protocol stack, the plurality of headers including a shim header having a first shim entry and a second shim entry associated with a predetermined network; wherein the first shim entry identifies the datagram as a monitoring datagram, the first shim entry being located next to the second shim entry and following the second shim entry.

According to a fifth aspect of the present invention, there is provided a use of a shim entry followed by and next to another shim entry to identify a datagram as a monitoring datagram, the shim entry and the another shim entry being associated with a same predetermined network.

It is thus possible to provide a method of constructing monitoring datagrams, as well as an apparatus for processing the monitoring datagrams, where the monitoring datagrams are not treated differently to other, content bearing, datagrams in terms of routing and queuing. It is also possible to measure datagram loss and delay across a Label Switched Path, not just at end-points, with improved accuracy over know techniques for measuring datagram loss and delay. Additionally, confidentiality of operational data of transit networks is preserved, because the shim entry pair corresponding to the monitoring status of the monitoring datagram is “pushed” further down the label stack. Consequently, monitoring datagrams are not recognised as such by routers of the transit networks.

### BRIEF DESCRIPTION OF DRAWINGS

At least one embodiment of the invention will now be described, by way of example only, with reference to the accompanying drawings, in which:

FIG. 1 is a schematic diagram of a network and datagrams constituting an embodiment of the invention;

FIG. 2 is a schematic diagram of a router constituting another embodiment of the invention;

FIG. 3 is a schematic diagram of shim headers;

FIG. 4 is a flow diagram of a method for use with the apparatus of FIG. 2; and

FIG. 5 is a schematic diagram of a tunnelling network constituting a further embodiment of the invention.

### DETAILED DESCRIPTION

Throughout the following description identical reference numerals will be used to identify like parts.

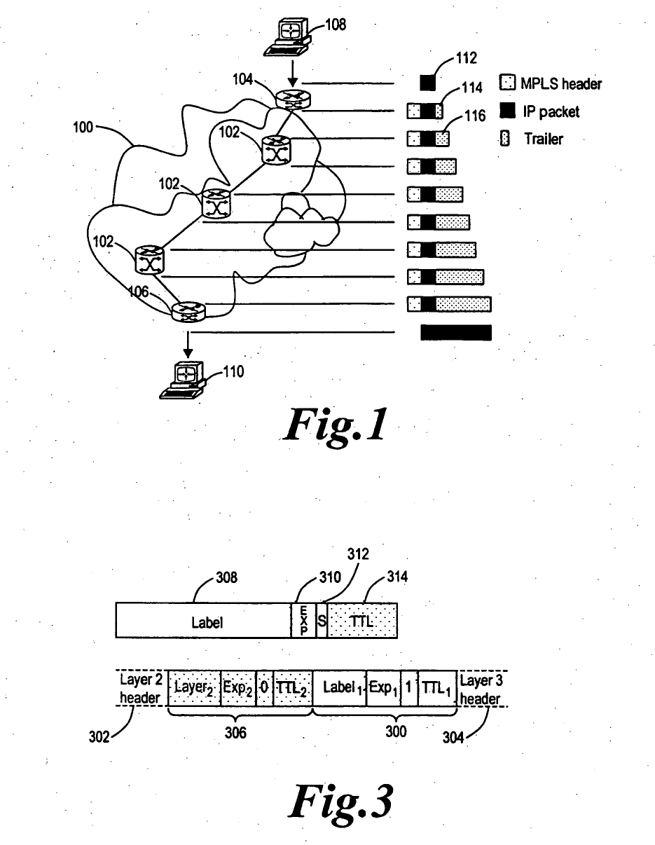

Referring to FIG. 1, a communications network, for example the Internet (not shown), can comprise a number of smaller networks, such as a Multi-Protocol Label Switching (MPLS) network 100 capable of supporting, for example a Virtual Private Network (VPN) with which a service level agreement is associated specifying acceptable datagram, or packet, loss rates.

The MPLS network 100 supports Label Switched Path (LSP) routing and the network 100 comprises a plurality of routers 102 to route packets between an ingress router 104 and an egress router 106. The ingress router 104 is capable of communicating with an ingress terminal 108, for example a first, suitably programmed, Personal Computer (PC), and the egress router 106 is capable of communicating with an egress terminal 110, for example a second, suitably programmed PC.

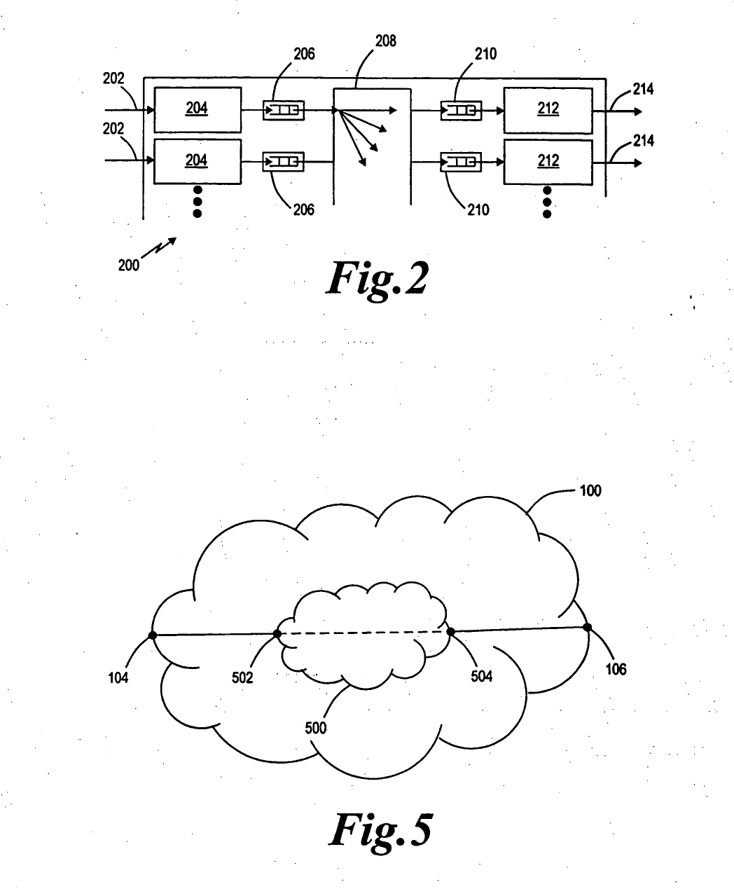

Referring to FIG. 2, each router 200 of the plurality of routers 102, as well as the ingress router 204 and the egress router 106 comprises a plurality of ingress ports 202, each coupled to a respective first plurality of trailer builder units 204. Each of the first plurality of trailer builder units 204 is respectively coupled to a plurality of ingress buffer 206, each ingress buffer 206 being coupled to a switching fabric 208. The switching fabric 208 is also coupled to a plurality of egress buffers 210, each egress buffer 210 being respectively coupled to a second plurality of trailer builder units 212. Each of the second plurality of trailer builder units 212 is respectively coupled to a plurality of egress ports 214. Of course, the above routers comprise other functional units, but these have not been described herein as they do not relate directly to the invention.

In operation, the ingress terminal 108 constructs a monitoring, or test, packet for receipt by the egress terminal 110. In this example, the ingress terminal 108 generates an IP packet 112 having an empty payload, for example an IPv4 packet, and encapsulates the IP packet by inserting (FIG. 3) a first MPLS shim header 300 between a layer 2 (transport layer) header 302 and a layer 3 (network layer) header 304. Next to the first MPLS shim header 300, a second MPLS shim header 306 is inserted so that the second shim header 306 encapsulates the already encapsulated IP packet 112.

As is known in the art, each of the first and second MPLS shim headers 300, 306 comprises a label field 308, an EXPerimental use (EXP) field 310, a bottom of Stack (S) field 312 and a Time To Live (TTL) field 314. In order to identify the monitoring packet as having a monitoring status, the label field 308 of the first shim header 300 is a NULL label, a reserved label that should, usually, only be found in a shim header that is not encapsulated by, or encapsulates, other shim headers between the layer 2 and layer 3 headers 302, 304. The second shim header 306 is a normal shim header having a label corresponding to a predetermined path terminating at the egress router 106. Hence, in this example, the illegal presence of the first shim header 300 having the NULL label encapsulated by, and therefore following and next to, the second shim header 306 is used to form the monitoring packet.

Instead of using the NULL label in the first shim header 300, another label can be reserved within the network 100 to indicate the monitoring status of the monitoring packet.

In order to gather, or harvest, data from one or more routers along a pre-determined path, i.e. a Label Switched Path (LSP), the ingress terminal 108, firstly, identifies the pre-determined path to be followed and assigns the label 308 and the EXP field 310 to the second shim header 306 accordingly when constructing the monitoring packet in the manner described above as is usual practice for MPLS networks. Thereafter, the monitoring datagram is communicated to the ingress router 104 by the ingress terminal 108 for injection into the network 100.

Upon receipt by the ingress router 104, the uppermost label, i.e. the label of the second shim header 306 of the monitoring packet, is identified and analysed by the ingress router 104, as is usual practice for MPLS routers, in order to determine the pre-determined path assigned to the monitoring packet. In this respect, the monitoring packet is treated in a same way to other, content bearing, MPLS packets and directed to an appropriate egress port 214 of the ingress router. However, unlike the usual practice for MPLS routers, the ingress router 104 also determines whether the second shim header 306 encapsulates another shim header, i.e. the first shim header 300. If the first shim header 300 is found below the second shim header 306, the ingress router 104 analyses the first shim header 300 to determine if the label of the first shim header 300 is the NULL label, or another reserved label, to indicate the monitoring status of the monitoring packet.

In the event that the monitoring packet is determined to possess the monitoring status, the ingress router 104 modifies the monitoring packet by appending a trailer 114 (FIG. 1) of bits to the payload of the monitoring packet defined by the second shim header 306, thereby extending the payload of the monitoring packet. The trailer of bits corresponds to data processed by the ingress router 104. The trailer of bits is appended to the payload of the monitoring packet after switching but prior to transmission to a first of the plurality of router 102.

In accordance with normal operation of the MPLS network 100, the monitoring packet is passed from router to router along the predetermined path until the egress router 106 receives the monitoring packet. In this example, at each of the plurality of routers 102, the router 102 operates in a like manner to the ingress router 104, but instead of only appending the trailer of bits just prior to egress, a trailer of bits 116 is also appended to the monitoring packet upon receipt of the monitoring packet. Whilst in this example, all the plurality of routers possess the trailer-appending functionality described above, it should be appreciated that only a number of the plurality of routers 102 can possess this functionality if need be.

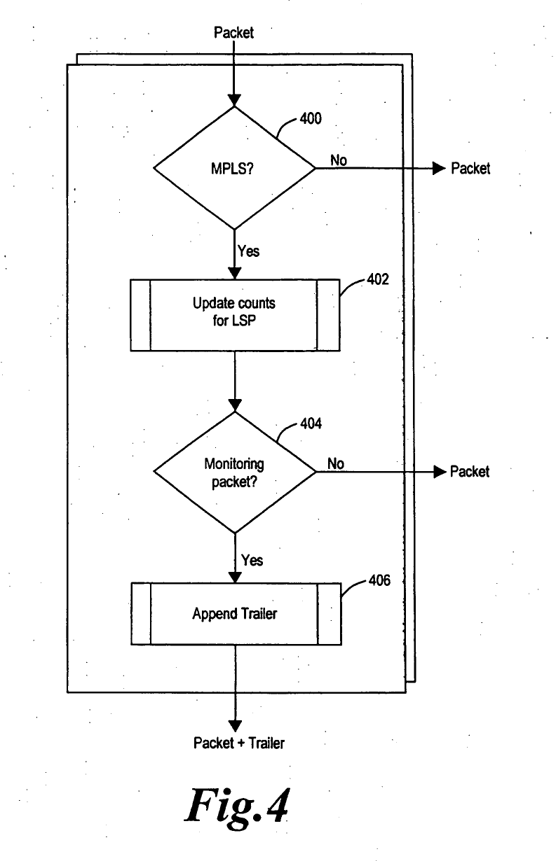

Referring to FIGS. 2 and 4, upon receipt of a packet at one of the plurality of ingress ports 202, the router 102 firstly determines (Step 400) if the monitoring packet is an LSP packet. If the packet received is not an LSP packet, the router 102 handles the received packet in the usual way that the router 102 handles non-LSP packets.

As would be expected, the router keeps one or more count of packets for one or more respective LSP that involves the router 102, and so if the received packet is determined to be an LSP packet, as in the case of the monitoring packet, the router 102 updates (Step 402) an appropriate packet count kept by the router 102 corresponding to the LSP of the received packet. Thereafter, a respective one of the plurality of first trailer builder units 204 performs the analysis described above to determine (Step 404) the monitoring status of the received packet, and appends (Step 406) the trailer of bits 116 described above to the payload of the monitoring packet if the received packet is determined to be a monitoring packet.

The modified monitoring packet is then queued in the respective ingress buffer 206 prior to admission to the switching fabric 208 for switching to the respective egress buffer 210 in accordance with the label of the second shim header 306.

Just prior to egress of the monitoring packet, i.e. after leaving the egress buffer 210 but before leaving the router 102, a respective one of the plurality of second trailer builder units 212 determines, once more, whether or not the monitoring packet is an LSP packet (Step 400), updates the packet count (Step 402), and then determines (Step 404) whether or not the monitoring packet has the monitoring status, and if so appends (Step 406) another trailer of bits.

The trailer of bits correspond to one or more of the following types of data: timestamp when a trailer is appended, packet count, label, EXP field and/or interface address. It should be appreciated, of course, that other types of data can also be used.

As can be seen from FIG. 1, the trailer of the monitoring packet grows as the monitoring packet passes through each of the plurality of routers 102 along the pre-determined path, until the monitoring packet is received by the egress router 106, where in an analogous manner to the ingress router 104, the egress router only appends the trailer of bits upon receipt of the monitoring packet, and not at the egress thereof, because upon receipt of the monitoring packet by the egress router 106, the monitoring packet is deemed to have exited to MPLS network 100.

Thereafter, upon receiving the monitoring packet and appending the trailer of bits, the egress router 106, in accordance with normal operation thereof, discards, or ‘pops’, the second shim header 306 to reveal the first shim header 300. The egress router 106 then analyses the first shim header 300 to determine of the label of the first shim header 300 is the NULL label or another reserved label indicative of the monitoring status. If the label of the first shim header 300 is the NULL, or another reserved, label then the first shim header 300 is discarded to reveal an IP header of the IP packet 112. Otherwise, the first shim header 300 possesses a label corresponding to a valid path, for example, in circumstances where the MPLS network 100 being a tunnelling network for another MPLS network, the monitoring, or other, packet is routed in accordance with the normal operation of the egress router 106.

If the first shim header 300 has been popped, the IP header is now the salient header for routing purposes and a payload length field (not shown) of the IP packet is consequently modified in order to merge the trailers that were appended to the monitoring datagram into the IP header. Thereafter, the now extended IP packet is routed to the egress terminal 110 for subsequent analysis of the monitoring packet. Due to the ability to use the IP header to forward the data of the monitoring packet to the egress terminal 110 or another remote monitoring server, the network monitoring function of a network provider does not have to be located at, or indeed close to, the egress router 106. Whilst, in this example, the trailers are appended to the payload of the monitoring packet, the above system can be arranged so that each router appends the trailers to the payload of the IP packet.

In order to provide the above described functionality to existing routers, some routers possessing a plurality of GigaBit Interface Converter (GBIC) modules to convert, in this example, optical signals into electrical signals and vice versa. The GBIC modules can be replaced by GBIC modules constructed to support appending trailers of bits to monitoring packets, thereby making it possible to retro-fit existing routers and avoiding complete replacement of routers in many circumstances. In such an embodiment, each GBIC module modifies the header of the IP packet of the monitoring packet to incorporate each appended trailer into the payload of the IP packet.

Each GBIC capable of appending trailers comprises a number of counters to keep count of packets associated with each LSP involving the GBIC. Further, if desired, one or more. GBIC can record a time at which a monitoring packet for a given LSP last passed through the GBIC. If subsequent to the recorded time a time-out period expires, the GBIC can switch to an active state in which the GBIC generates one or more monitoring packet for the given LSP and injects the one or more monitoring packet into the LSP. Optionally, the GBIC can return to a passive state and cease the generation of monitoring packets once monitoring packets begin to be received from a router/GBIC upstream of the GBIC, subject to the continued receipt of monitoring packets within the time-out period for the LSP. In order to support generation of monitoring packets, the GBICs capable of such functionality are pre-configured with the IP address of the monitoring station.

For certain applications involving the GBICs, it can be necessary to generate the IP packet with the maximum payload permitted by “stuffing” the payload with redundant bits, a number of the redundant bits being gradually replaced each time a trailer needs to be added. Clearly, in this example, instead of the payload being extended to add a trailer, redundant bits are replaced.

The data harvested by the monitoring packet can be used to calculate packet loss rates and internal delays of routers that provide a pair of trailers, local synchronisation in relation to routers being relatively easily achievable for calculation of internal delays. However, if the ingress router 104, the egress router 106 and the plurality of routers 102 are synchronised, i.e. synchronisation over a greater distance is achieved, it is also possible to calculate an end-to-end delay between the ingress router 104 and the egress router 106 for the predetermined path. Sometimes, delays experienced by packets between routers is fixed and known and so by calculating the internal delay of the routers between the ingress router 104 and the egress router 106, the end-to-end delay can still nevertheless be calculated in an alternative manner without requiring synchronisation over the greater distance. The data collected by the monitoring packet can also be used to calculate packet jitter by, for example, the injection of two monitoring packets into the ingress router 104 at substantially the same time and calculating a time difference between times of arrival of the two packets at the egress router 106.

In another embodiment involving tunnelling networks, as briefly mentioned above, the MPLS network 100 can possess an MPLS tunnelling network 500 within (FIG. 5). In this embodiment, the monitoring packet is injected into the MPLS network 100 and routed within the MPLS network 100, trailers also being appended to the monitoring packet where appropriate, in the manner already described above until another ingress router 502 of the MPLS tunnelling network 500 is reached. The ingress router 502 of the MPLS tunnelling network 500 then encapsulates the monitoring packet with a third shim header (not shown) specific to the MPLS tunnelling network 500 and the encapsulated monitoring packet is routed to an egress router 504 of the MPLS tunnelling network 500 by routers (not shown) of the MPLS tunnelling network 500.

At the egress router 504 of the MPLS tunnelling network 500, the third shim header is popped to reveal the second shim header 302, the monitoring packet being forwarded to one of the plurality of routers 102 for onward communication to the egress router 106 of the MPLS network 100 once the monitoring packet has exited to MPLS tunnelling network 500.

In can therefore be seen that during passage through the MPLS tunnelling network 500, the monitoring packet is treated like any other LSP packet and so the routers of the MPLS tunnelling network 500 do not treat the monitoring packet as such and do not append potentially sensitive data about the tunnelling network 500 to the monitoring packet originating from outside the tunnelling network 500, thereby retaining confidentiality of the operation of the tunnelling network 500 from the operator of the MPLS network 102.

Whilst the above embodiments have been described in the context of MPLS networks, it should be appreciated that the principles of the above embodiments can be applied to other types of networks providing comparable features to MPLS networks for realising the above-described functionality.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

1. A method of generating a monitoring datagram for a predetermined network, the method comprising the steps of:
generating an initial datagram;
encapsulating the initial datagram with a shim header, the shim header having a first shim entry and a second shim entry, the first and second shim entries being associated with the predetermined network; wherein
the first shim entry is next to and follows the second shim entry, the first shim entry identifying the initial datagram as having a monitoring status.

2. A method as claimed in claim 1, including the step of: further encapsulating the datagram encapsulated by the second shim entry using a third shim entry associated with another network distinct from the predetermined network.

3. A method as claimed in claim 1, wherein the monitoring datagram comprises temporary data to ensure a payload is of an initial predetermined length.

4. A method as claimed in claim 1, including receipt of an encapsulated datagram and processing thereof by:
identifying a first shim entry and a second shim entry associated with the predetermined network, the first shim entry being next to and following the second shim entry; and
recording data of a predetermined type relating to the datagram in response to the first shim entry bearing an identifier to identify the datagram as having a monitoring status.

5. A method as claimed in claim 4, wherein the data of the predetermined type is associated with the monitoring datagram and a predetermined path being followed by the monitoring datagram.

6. A method as claimed in claim 4, wherein the data of the predetermined type is at least one of: timestamp data, a label, an exp field, a packet count and an interface address.

7. A method as claimed in claim 4, wherein the data of the predetermined type is recorded by appending the predetermined data to a payload associated with the second shim entry.

8. A method as claimed in claim 4, wherein the data of the predetermined type is recorded by modifying at least part of the payload of the datagram so as to contain the data of the predetermined type.

9. A method of calculating a network performance statistic comprising the steps of:
generating a monitoring datagram by the method as claimed in claim 1;
harvesting monitoring data by processing, at least once, the monitoring datagram, by identifying a first shim entry and a second shim entry associated with the predetermined network, the first shim entry being next to and following the second shim entry, and recording data of a predetermined type relating to the datagram in response to the first shim entry bearing an identifier to identify the datagram as having a monitoring status; and
determining the network performance statistic using the harvested monitoring data.

10. A method as claimed in claim 9, wherein the network performance statistic is datagram loss.

11. A method as claimed in claim 9, wherein the network performance statistic is an end-to-end delay of the monitoring datagram between an ingress point and an egress point associated with a path for routing the monitoring datagram.

12. A method as claimed in claim 9, wherein the network performance statistic is an internal delay of a network element.

13. A method as claimed in claim 1, including retrieval of monitoring data from an encapsulated monitoring datagram by:
receiving, at an egress point of a communications network, the monitoring datagram, the monitoring datagram comprising a payload, the first shim entry and the second shim entry, the first and second shim entries corresponding to a label stack;
discarding the second shim entry to reveal the first shim entry as an uppermost shim entry in the label stack;
discarding the first shim entry to reveal a header; and
forwarding the payload of the monitoring datagram to an appropriate network element in accordance with the header.

14. A computer program product comprising a computer usable medium having computer program code that when executed on a computer causes the computer to execute a method of generating a monitoring datagram for a predetermined network, the method including:
generating an initial datagram; and
encapsulating the initial datagram with a shim header, the shim header having a first shim entry and a second shim entry, the first and second shim entries being associated with the predetermined network,
wherein the first shim entry is next to and follows the second shim entry, the first shim entry identifying the initial datagram as having a monitoring status.

15. An apparatus for processing a monitoring datagram, the apparatus comprising:
an ingress port for receiving a datagram comprising a plurality of headers corresponding to a protocol stack;
a data processing unit for supporting a header analysis entity, the analysis entity being arranged to identify, when in use, a first shim entry and a second shim entry associated with a predetermined network, the first shim entry being next to and following the second shim entry, the header analysis entity being further arranged to record data of a predetermined type relating to the datagram in response to the first shim entry bearing an identifier to identify the datagram as a monitoring datagram.

16. A communications network comprising the apparatus as claimed in claim 15.

17. Interface apparatus comprising the apparatus as claimed in claim 15, and arranged to retain at least one count of packets that pass, when in use, through the interface apparatus.

18. The interface apparatus as claimed in claim 17, arranged to generate monitoring datagrams for a path to be monitored in response to an absence of receipt of monitoring datagrams for the path for a predetermined period of time, and to cease generation of monitoring datagrams for the path in response to receipt of a monitoring datagram for the path.

19. A monitoring datagram comprising:
a payload;
a plurality of headers corresponding to a protocol stack, the plurality of headers including a shim header having a first shim entry and a second shim entry associated with a predetermined network;
wherein the first shim entry identifies the datagram as a monitoring datagram, the first shim entry being located next to the second shim entry and following the second shim entry.

20. A use of a shim entry followed by and next to another shim entry to identify a datagram as a monitoring datagram, the shim entry and the another shim entry being associated with a same predetermined network.
